(19) United States
(12) Patent Application Publication
(10) Pub. No.: US 2023/0177314 A1
(43) Pub. Date: Jun. 8, 2023

(54) METHOD AND SYSTEM FOR OPTIMIZING QUANTIZATION MODEL

(71) Applicant: NOTA, INC., Daejeon (KR)

(72) Inventors: Seohyun Jeon, Daejeon (KR); Junkyu Park, Daejeon (KR); Tae-Ho Kim, Daejeon (KR)

(73) Assignee: NOTA, INC., Daejeon (KR)

(21) Appl. No.: 18/061,305

(22) Filed: Dec. 2, 2022

(30) Foreign Application Priority Data
Dec. 3, 2021 (KR) 10-2021-0171945
Mar. 7, 2022 (KR) 10-2022-0028923

(51) Int. Cl. G06N 3/045; G06N 3/08

(52) U.S. Cl. CPC G06N 3/045; G06N 3/08

(57) ABSTRACT

Disclosed is a method and system for optimizing a quantization model. A quantization model optimization method may include receiving an input of the quantization model; extracting at least one of a weight and an activation, and a quantization parameter of the at least one of the weight and the activation by analyzing the input quantization model; selecting at least one of the weight and the activation of the input quantization model as a target element to be modified; adjusting a clipping range related to the quantization parameter of the target element; recomputing the quantization parameter of the target element based on the adjusted clipping range; and generating an adjusted quantization model by applying the recomputed quantization parameter to the input quantization model.

### CROSS-REFERENCE TO RELATED APPLICATION

This application claims the priority benefit of Korean Patent Application No. 10-2021-0171945, filed on Dec. 3, 2021, and Korean Patent Application No. 10-2022-0028923, filed on Mar. 7, 2022, in the Korean Intellectual Property Office, the disclosure of which is incorporated herein by reference.

### BACKGROUND

### 1. Field of the Invention

The following description of example embodiments relates to a quantization model optimization method and system for restoring an accuracy by modifying a quantization model generated by a compiler.

### 2. Description of the Related Art

Attempts using a deep learning model to effectively perform taskings such as image processing and natural language processing are actively being made. However, since a large amount of computation and memory resources are required to run the deep learning model, it is a great burden to run the deep running model in a high-performance server as well as an embedded device with limited resources.

Therefore, various lightweight methods, for example, pruning, filter decomposition, and quantization methods, are used to more effectively run a model. Here, the quantization method refers to a deep learning lightweight method that expresses a number represented with a 32-bit floating point (FP) method that is a default method, using fewer bits.

The deep learning model is generated through a deep learning compiler, such as TensorFlow or PyTorch. Also, a quantization process is preconfigured in the deep learning compiler and provides a function such that a user may perform quantization. Since the quantization process is related to various portions of the deep compiler, it is very difficult for the user to directly implement the quantization. Therefore, it is common for the user to use a quantization function provided from the deep learning compiler, such as TensorFlow Lite or TensorRT. The deep learning compiler generates a quantized model by computing a quantization parameter (a scale, a zero point, etc.) using an equation and then storing the computed quantization parameter with a weight, a bias, and an activation of the model.

Since the quantized model uses fewer bits than a 32-bit floating point (FP) model, a quantization loss occurs and the quantization loss causes a degradation in an accuracy of the deep learning model. Since the deep learning compiler is a very complex system, it is not easy for the user to directly modify the quantization process of the compiler.

Also, a development process of the deep learning model is largely divided into training and inference and datasets used for the training and the inference theoretically have the same distribution. However, due to uncertainty of an actual environment, a distribution of datasets between training and actual inference environments may be different. Since a different dataset is used for each of training and inference, a model trained using training data demonstrates a degraded performance compared to a training performance in an actual dataset used for inference. A distribution of actual datasets used for inference may differ from a training data distribution based on (1) to (3) as follows:

(1) If the deep learning model runs in various environments, a performance for each environment is different. For example, in the case of a model that recognizes a vehicle on an intersection, if the model collects data at a single interaction and then performs inference at another interaction, an inference environment and a training environment are different and a data distribution is different, leading to a degradation in the performance.

(2) According to an increase in a number of intersections, an environment at each intersection also becomes more diverse and the diversity of training environments becomes more prominent.

(3) Even in the same environment, in an external environment other than a laboratory, features of a scene vary little by little according to various physical factors or a change in a natural environment (e.g., sunlight, season, weather, etc.), which may be a factor that decreases the accuracy of the deep learning model.

Here, a finetuning method is adopted as a general method to prevent a degradation in a model accuracy. Finetuning refers to a method of modifying a structure of a model to fit a newly collected dataset based on an existing trained model and retraining and updating the model from weights of the trained model.

However, the finetuning method requires computing resources and time for retraining and there is an inconvenience of having to iteratively perform training if a desired performance is not obtained. Also, a model needs to be finetuned whenever an environmental change occurs. Therefore, a factor of retraining after initial training may be one of factors that make it difficult to maintain and manage performance of the deep learning model in an environment in which the deep learning model is deployed.

To overcome the degradation in the performance of the deep learning model caused by the environmental change after initial model training, the performance of the deep learning model may be maintained by continuously finetuning the model according to an environment in which the deep learning model is deployed. Currently, a retraining process that is a method generally used for finetuning requires cost such as a large amount of time and computing resources. Also, the finetuning method has a disadvantage in that data for training is additionally required and when training is performed from scratch by combining the added data with an existing dataset, an amount of data increases and training cost significantly increases. Also, since the finetuning method needs to perform finetuning in each of environments in which the deep learning model is deployed, cost increases according to an increase in the number of environments in which the deep learning model is deployed. Therefore, there is a need for a method of further easily and quickly performing finetuning.

### SUMMARY

Example embodiments provide a quantization model optimization method and system that may recover a degradation in an accuracy using a quantized model that is generated by a deep learning compiler and a quantization parameter present in the quantization model without modifying an internal code of the deep learning compiler.

Example embodiments provide a quantization model optimization method and system that may generate an environment-adaptive deep learning model by calibrating a quantization parameter of a quantized model that is generated by quantizing the deep learning model.

According to an example embodiment, there is provided a method of optimizing a quantization model performed by a computer device including at least one processor, the method including receiving, by the at least one processor, an input of the quantization model; extracting, by the at least one processor, at least one of a weight and an activation, and a quantization parameter of the at least one of the weight and the activation by analyzing the input quantization model; selecting, by the at least one processor, at least one of the weight and the activation of the input quantization model as a target element to be modified; adjusting, by the at least one processor, a clipping range related to the quantization parameter of the target element; recomputing the quantization parameter of the target element based on the adjusted clipping range; and generating, by the at least one processor, an adjusted quantization model by applying the recomputed quantization parameter to the input quantization model.

According to an aspect, the selecting the target element may include selecting the target element for each channel or for each layer of the input quantization model.

According to another aspect, the adjusting the clipping range may include adjusting the clipping range by increasing or decreasing at least one of a minimum value and a maximum value for the selected target element.

According to still another aspect, the computing the quantization parameter may include recomputing a scale factor and a zero point as the quantization parameter of the target element according to the adjusted clipping range.

According to still another aspect, the selecting at least one of the weight and the activation, the adjusting the clipping range and the recomputing the quantization parameter may be iteratively performed.

According to still another aspect, the method may further include determining the recomputed quantization parameter among a plurality of candidate quantization parameters obtained by iteratively performing the selecting, the adjusting and the recomputing.

According to an example embodiment, there is provided a method of optimizing a quantization model performed by a computer device including at least one processor, the method including receiving, by the at least one processor, an input of the quantization model; generating, by the at least one processor, a plurality of deep learning models by modifying a quantization parameter of the input quantization model; measuring, by the at least one processor, an accuracy of each of the plurality of deep learning models by applying a representative dataset generated in advance to represent an arbitrary environment to each of the plurality of deep learning models; and determining, by the at least one processor, one of the plurality of deep learning models as an optimized quantization model for the arbitrary environment based on the measured accuracy. The modifying the quantization parameter of the input quantization model includes selecting at least one of the weight and the activation of the input quantization model as a target element to be modified; adjusting a clipping range related to the quantization parameter of the target element; and modifying the quantization parameter of the target element based on the adjusted clipping range.

According to an aspect, the selecting the target element may include selecting the target element for each channel or for each layer of the input quantization model.

According to another aspect, the adjusting the clipping range may include adjusting the clipping range by increasing or decreasing at least one of a minimum value and a maximum value for the selected target element.

According to still another aspect, the modifying the quantization parameter may include recomputing a scale factor and a zero point as the quantization parameter of the target element according to the adjusted clipping range.

According to still another aspect, the plurality of deep learning models are generated so that a target element or an adjusted clipping range of one of the plurality of deep learning models is different from others of the plurality of deep learning models.

According to still another aspect, the measuring the accuracy and the determining as the optimized quantization model are iteratively performed to different representative datasets generated in advance to represent different environments.

According to an example embodiment, there is provided a non-transitory computer-readable recording medium storing a program to implement the method of a computer device.

According to an example embodiment, there is provided a computer device including at least one processor configured to execute a computer-readable instruction on the computer device. The at least one processor is configured to receive an input of a quantization model, to extract at least one of a weight and an activation, and a quantization parameter of the at least one of the weight and the activation by analyzing the input quantization model, to select at least one of the weight and the activation of the input quantization model as a target element to be modified, to adjust a clipping range related to the quantization parameter of the target element, to recompute the quantization parameter of the target element based on the adjusted clipping range, and to generate an adjusted quantization model by applying the recomputed quantization parameter to the input quantization model.

According to some example embodiments, it is possible to recover a degradation in an accuracy using a quantization model generated by a compiler and a quantization parameter present in the quantization model without modifying an internal code of a deep learning compiler.

According to some example embodiments, it is possible to generate an environment-adaptive deep learning model by calibrating a quantization parameter of a quantized model that is generated by quantizing the deep learning model.

According to some example embodiments, since a quantized model is not trained through finetuning, it is possible to significantly decrease cost such as an amount of time and computing resources compared to an existing method.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of a lightweight process according to an example embodiment;

FIG. 2 is a flowchart illustrating an example of a quantization method according to an example embodiment;

FIG. 3 is a diagram illustrating an example of a computer device according to an example embodiment; and

FIG. 4 is a flowchart illustrating an environment-adaptive deep learning model generation method according to an example embodiment.

### DETAILED DESCRIPTION

Hereinafter, example embodiments will be described with reference to the accompanying drawings.

A deep learning compiler covers all aspects related to deep learning. That is, training and inference are covered here and implemented using various lightweight methods. In particular, a quantization part needs to be implemented in consideration of execution on a target device and thus, is significantly related to a code for runtime execution. Therefore, to modify a quantization method in a user-desired manner within the deep learning compiler, it is necessary to understand all the related implementations and it is not easy to modify a quantization function in reality.

Also, there are various compilers, for example, PyTorch, TensorFlow, TensorFlow Lite, and TensorRT, and each compiler may be implemented using various methods. Therefore, it is impossible for a user to work in all the environments.

On the other hand, although a quantized model that is generated by a compiler may be in a different format for each compiler, each quantization model has the same quantization parameter. That is, since the quantized model unconditionally has the same quantization parameter such as a scale factor and a zero point, quantized information may be extracted from a result model by obtaining such values. If the user directly modifies quantization information to a desired value, it may achieve the same effect as that of modifying a quantization function of a compiler. Therefore, a method of directly modifying the quantized model may be performed without a need to be aware of an internal structure and an internal method of the compiler.

Here, it is not easy for the user to directly modify quantization information to a desired value since it is difficult for the user to directly perform an analysis according to an error by quantization and tendency may vary according to a situation, such as data and the deep learning model. Therefore, proposed is herein a method that allows the user to achieve the improvement of an accuracy without a need to directly adjust a quantization parameter.

In general, a training or retraining process using training data is required to improve the accuracy of deep learning. However, a time and computer resources for training are required for training and, in retraining, the improvement of accuracy is not guaranteed at all times. Also, there are many situations in which it is difficult to obtain data due to security issues. A calibration method proposed herein may decrease a loss of accuracy of a quantized deep learning model without using data and without using a time and cost for training.

The deep learning model generally uses a 32-bit floating point (FP) number. However, a quantization method may be used to use a number format with a number of bits less than 32 bits. Through this process, a loss may occur in terms of accuracy. A size of a model may be reduced and a memory may be effectively used and an execution speed may increase accordingly.

Quantization may be largely divided into a uniform quantization method and a non-uniform quantization method. The uniform quantization method refers to a method of equally dividing a quantization section and may be performed through the following Equation 1 to Equation 3.

$$clamp ( r ; a , b ) := min ( max ( r , a ) , b ) \qquad [ Equation 1 ]$$

$$s ( a , b , n ) := \frac{b - a}{n - 1} \\ z = - round ( \frac{b}{s} ) - {2}^{k - 1} \qquad [ Equation 2 ]$$

$$q ( r ; a , b , n ) := [ \frac{clamp ( r ; a , b ) - a}{s ( a , b , n )} ] s ( a , b , n ) + a \qquad [ Equation 3 ]$$

The uniform quantization method may perform clipping with the range of [a, b] for an input value of r through Equation 1. Also, the uniform quantization method may obtain a scale factor (s) and a zero point (z) using Equation 2. Here, this is equivalent to that, with the assumption that k bits are used, n=2^{k} and the range of [a, b] is divided into quantized intervals to be expressed in k bits. Also, the uniform quantization method may compute a quantized value for the input value using Equation 3. Equation 1 to Equation 3 are examples of equations related to a method that uses a scale factor and a zero point as a quantization parameter in the uniform quantization method. A type of the quantization parameter may vary according to a representation method.

In addition to the uniform quantization method, there is the non-uniform quantization method of unequally dividing the range of [a, b]. In this case, there may be a parameter in addition to the scale factor and the zero point.

A quantization process may be individually applied to values of a weight, a bias, and an activation of a model. That is, the weight, the bias, and the activation have different quantization parameters, respectively. A unit (quantization granularity) in which a quantization parameter is shared may vary depending on implementation. In the case of TensorFlow Lite, the weight and the bias share the quantization parameter based on a channel unit and the activation shares the quantization parameter based on a layer basis.

For example, an error occurring when performing quantization largely includes a clipping error and a quantization error. A total sum of the two errors according to the clipping range becomes a final quantization loss. The clipping error refers to an error that occurs in a process of clipping with a value smaller than a maximum value or clipping with a value larger than a minimum value in the quantization process. In the quantization process, values between the minimum value and the maximum value are mapped to a section that may be expressed in k bits. An error that occurs at this time is a quantization error. Therefore, if a section between the minimum value and the maximum value, that is, the clipping range is reduced, the clipping error increases but the quantization error decreases. Here, if the clipping range is changed to decrease a total sum of the two errors, an accuracy may be improved.

Weight and bias values may be stored in a quantized model file generated by a compiler. Also, the scale factor and the zero point may be stored in the quantized model file according to quantization granularity. Here, the zero point may have the same type as a quantized value. For example, if the model is quantized to “int8”, the zero point may also have the type “int8”. The scale factor is in a form of a positive real number.

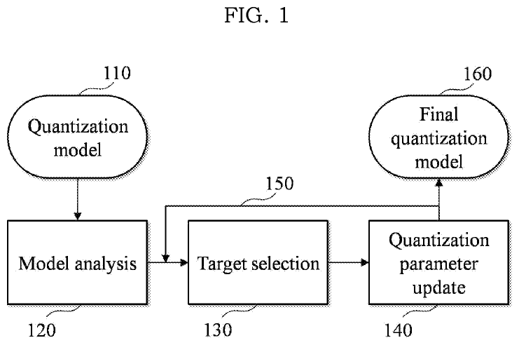

FIG. 1 illustrates an example of a lightweight process according to an example embodiment.

A quantization model 110 may represent a model of which quantization is completed by a deep learning compiler. Taking TensorFlow as an example, a quantized model file has an extension of “tfilte” and a quantized model with various data types, such as “int8”, “fp16”, etc., may be used as the quantization model 110.

A model analysis process 120 may be an example of a process of parsing an input model, for example, the quantization model 110 and obtaining a weight and a quantization parameter of the model. Here, the quantization parameter may be present for each quantization granularity (e.g., channel or layer). Using the obtained quantization parameter, internal values used in Equation 1 to Equation 3 may be computed.

A target selection process 130 may be an example of selecting a target for modifying a quantization parameter. Any of a weight, a bias, and an activation may be the target. That is, at least one of the weight, the bias, and the activation may be selected as the target. Also, a unit of the target may follow the quantization granularity of the input model. That is, if the weight and the bias are for each channel and the activation is for each layer as the quantization parameter in the input model, all of the weight and the bias and the activation may be selected for each channel or for each layer as the target for modifying the quantization parameter.

A quantization parameter update process 140 may be an example of a process of a first method of increasing or decreasing a minimum value (a), a second method of increasing or decreasing a maximum value (b), or a third method of simultaneously performing the first method and the second method. Changing the minimum value and/or the maximum value may have the following effects: Initially, with the assumption that a difference between the maximum value and the minimum value (b−a) is the clipping range, if the clipping range becomes larger than before through the quantization parameter update process 140, the quantization error increases but the clipping error decreases. On the contrary, if the clipping range becomes smaller than before, the clipping error increases but the quantization error decreases. If the minimum value (a) and the maximum value (b) are changed (increases or decreases) by the same size, the clipping range is the same as before. Therefore and, the quantization error is the same but the clipping error varies.

Here, a change in accuracy that occurs in response to the change in the clipping range very differently occurs according to data, a type of a deep learning network, and the like. A method of (a zero-shot method) of updating the quantization parameter to a preset value only once and a method (a search method) of finding a parameter capable of obtaining a better accuracy by iteratively performing an update process may be employed. The zero-shot method and the search method are further described below.

Here, in the quantization parameter update process 140, a new quantization parameter value may be computed according to newly set minimum and/or maximum values. For example, to use a newly set clipping range, a new scale factor and zero point may be computed according to the above Equation 2 and then may be applied to a model file and stored.

An indicator with an arrowhead 150 may represent that the target selection process 130 and the quantization parameter update process 140 may be iteratively performed. That is, through the zero-shot method, the quantization model 110 may be updated by performing the target selection process 130 and the quantization parameter update process 140 only once. Also, through the search method, the quantization model 110 may be updated by performing the target selection process 130 and the quantization parameter update process 140 multiple times.

The zero-shot method refers to a method of temporarily performing quantization parameter update only once. The zero-shot method proposes a result model that is a model obtained as a result of performing a plurality of update methods based on maximum/minimum values of an existing input model. The zero-shot method has some advantages in that training data or validation data is not used and a relatively short period of time is used to perform the zero-shot method.

The search method refers to a method of iteratively performing quantization parameter update (i.e., repeating the target selection process 130 and the quantization parameter update process 140) to obtain a better model accuracy using a portion of training data or validation data. A plurality of quantization parameter candidates may be generated by repeating quantization parameter update. As a method of finding a better way among a plurality of candidates, for example, the plurality of quantization parameter candidates, the search method may use a Bayesian optimization, an evolutionary algorithm, a gradient-based optimization method, a reinforcement learning (RL)-based method, and the like. Here, a method, such as a hyper parameter optimization (HPO) and a neural architecture search (NAS), may be applied.

A final quantization model 160 may be in the same format as that of the quantization model 110 and may be a model in which an internal quantization parameter of the quantization model 110 is changed.

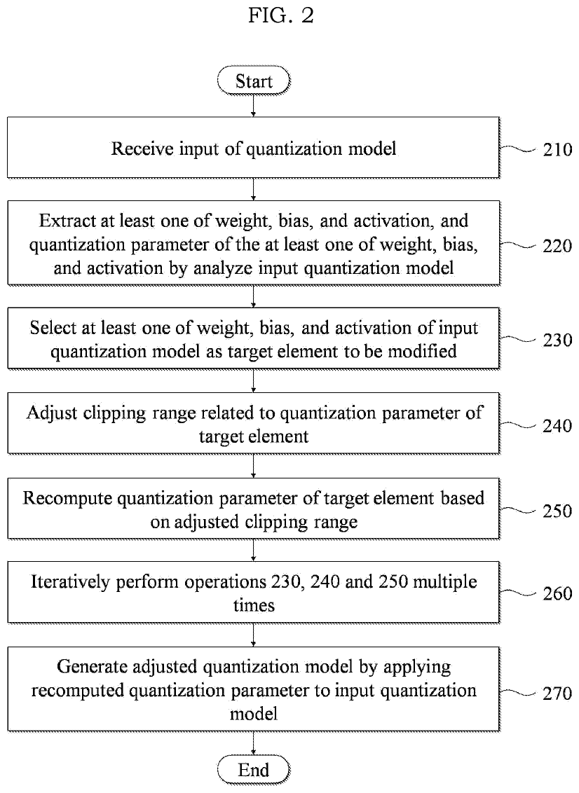

FIG. 2 is a flowchart illustrating an example of a quantization method according to an example embodiment. Operations 210 to 260 included in the quantization method of FIG. 2 may be performed by at least one computer device.

In operation 210, the computer device may receive an input of a quantization model. For example, the computer device may receive a file of the quantization model generated by a deep learning compiler.

In operation 220, the computer device may extract at least one of a weight, a bias, and an activation, and a quantization parameter of the at least one of the weight, a bias, and an activation by analyzing the input quantization model. For example, the computer device may parse the file of the quantization model and may extract the quantization parameter and at least one of the weight, the bias, and the activation of the quantization model included in the corresponding file.

In operation 230, the computer device may select at least one of the weight, the bias, and the activation of the input quantization model as a target element to be modified. As described above, the computer device may select the target element for each channel of the weight and the bias or for each layer of the activation. For example, the computer device may select the target element for each channel or for each layer of the input quantization model.

In operation 240, the computer device may adjust a clipping range related to the quantization parameter of the target element. For example, the computer device may adjust the clipping range by increasing or decreasing at least one of a minimum value and a maximum value for the selected target element. As described above, with the assumption that a difference between the maximum value and the minimum value (b−a) for the target to be modified is the clipping range, if the clipping range becomes larger than before, a quantization error may increase but a clipping error may decrease. On the contrary, if the clipping range becomes smaller than before, the clipping error may increase but the quantization error may decrease. If the minimum value (a) and the maximum value (b) are changed (increases or decreases) by the same size, the clipping range is the same as before. Therefore, the quantization error may be the same but the clipping error may vary.

In operation 250, the computer device may recompute the quantization parameter of the target element based on the adjusted clipping range. Here, the computer device may recompute a scale factor and a zero point as the quantization parameter of the target element according to the adjusted clipping range. That is, the computer device may adjust an accuracy of the quantization model through a change in an error (an increase and/or a decrease in the quantization error and/or the clipping error) according to the adjustment of the clipping range.

As described above, recomputing the quantization parameter may be performed only once and may also be performed multiple times. In this manner, an optimal candidate to restore the accuracy of the quantization model may be obtained. Operation 260 may be included in the accuracy restoration method according to an example embodiment of performing recomputing the quantization parameter multiple times and may be omitted in the accuracy restoration method according to an example embodiment of performing recomputing the quantization parameter only once.

In operation 260, the computer device may iteratively perform operations 230, 240 and 250 multiple times. Here, the computer device may select at least one candidate from among a plurality of candidates as the quantization parameter that is obtained through multiple iterations in operation 260. In this case, the optimal candidate may be selected from among the plurality of candidates based on the accuracy.

In operation 270, the computer device may generate an adjusted quantization model by applying the recomputed quantization parameter to the input quantization model. When operation 260 is performed, the recomputed quantization parameter selected as the optimal candidate may be applied to the input quantization model. When operation 260 is not performed, the quantization parameter recomputed in operation 250 may be applied to the input quantization model.

As described above, the computing device may recover a degradation in the accuracy using the quantization model generated by the compiler and the quantization parameter present in the model without modifying an internal code of the deep learning compiler.

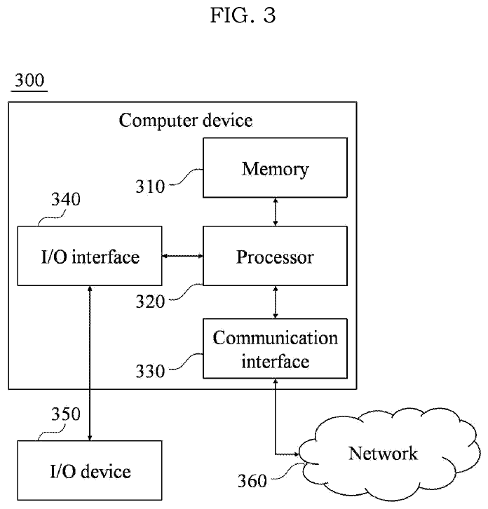

FIG. 3 is a diagram illustrating an example of a computer device according to an example embodiment. A computer device 300 may correspond to the computer device described above with reference to FIG. 2. Referring to FIG. 3, the computer device 300 may include a memory 310, a processor 320, a communication interface 330, and an input/output (I/O) interface 340. The memory 310 may include a permanent mass storage device, such as a random access memory (RAM), a read only memory (ROM), and a disk drive, as a non-transitory computer-readable recording medium. Here, the permanent mass storage device, such as a ROM and a disk drive, may be included in the computer device 300 as a permanent storage device separate from the memory 310. Also, an operating system (OS) and at least one program code may be stored in the memory 310. Such software components may be loaded to the memory 310 from another non-transitory computer-readable recording medium separate from the memory 310. The other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 310 through the communication interface 330, instead of the non-transitory computer-readable recording medium. For example, the software components may be loaded to the memory 310 of the computer device 300 based on a computer program installed by files received over a network 360.

The processor 320 may be configured to process instructions of a computer program by performing basic arithmetic operations, logic operations, and I/O operations. The computer-readable instructions may be provided by the memory 310 or the communication interface 330 to the processor 320. For example, the processor 320 may be configured to execute received instructions in response to a program code stored in a storage device, such as the memory 310.

The communication interface 330 may provide a function for communication between the communication device 300 and another apparatus, for example, the aforementioned storage devices. For example, the processor 320 of the computer device 300 may forward a request or an instruction created based on a program code stored in the storage device such as the memory 310, data, and a file, to other apparatuses over the network 360 under control of the communication interface 330. Inversely, a signal, an instruction, data, a file, etc., from another apparatus may be received at the computer device 300 through the communication interface 330 of the computer device 300. For example, a signal, an instruction, data, etc., received through the communication interface 330 may be forwarded to the processor 320 or the memory 310, and a file, etc., may be stored in a storage medium, for example, the permanent storage device, further includable in the computer device 300.

The I/O interface 340 may be a device used for interfacing with an I/O device 350. For example, an input device may include a device, such as a microphone, a keyboard, a mouse, etc., and an output device may include a device, such as a display, a speaker, etc. As another example, the I/O interface 340 may be a device for interfacing with an apparatus in which an input function and an output function are integrated into a single function, such as a touchscreen. The I/O device 350 may be configured as a single apparatus with the computer device 300.

Also, according to other example embodiments, the computer device 300 may include a greater or smaller number of components than the number of components of FIG. 3. However, there is no need to clearly illustrate many conventional components. For example, the computer device 300 may be configured to include at least a portion of the I/O device 350 or may further include other components, such as a transceiver and a database.

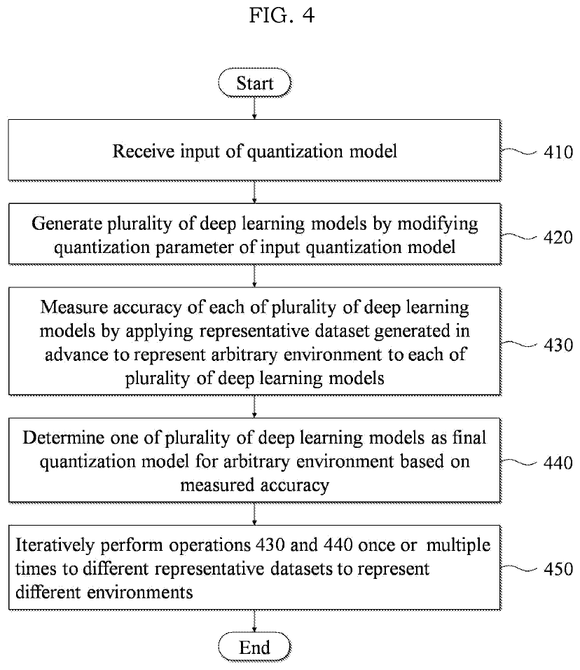

FIG. 4 is a flowchart illustrating an example of a method of generating an environment-adaptive deep learning model according to an example embodiment. The method of generating an environment-adaptive deep learning model according to the example embodiment may be performed by the computer device 300 of FIG. 3. Here, the processor 320 of the computer device 300 may be configured to execute a control instruction according to a code of at least one computer program or a code of an OS included in the memory 310. Here, the processor 320 may control the computer device 300 to perform operations 410 to 450 included in the method of FIG. 4 according to a control instruction provided from a code stored in the computer device 300.

In operation 410, the computer device 310 may receive an input of a quantization model. For example, the computer device 300 may receive an input of a file of the quantization model generated by a deep learning compiler. The deep learning compiler is described above.

In operation 420, the computer device 300 may generate a plurality of deep learning models by modifying a quantization parameter of the input quantization model. Here, the computer device 300 may generate the plurality of deep learning models by modifying the quantization parameter such that at least one of a target element to be modified for modifying the quantization parameter and a clipping range is different.

A method of modifying the quantization parameter is described above with reference to FIGS. 1 and 2. The computer device 300 may recover a degradation in an accuracy using the quantization model generated by the compiler and the quantization parameter present in the model without modifying an internal code of the deep learning compiler. Here, it would be easily understood that the plurality of deep learning models in which the quantization parameter is variously modified may be obtained in operation 420 of FIG. 4 by changing the target element to be modified (e.g., at least one of the weight, the bias, and the activation selected in operation 220 of FIG. 2 and the clipping range adjusted in operation 230 of FIG. 2.

In operation 430, the computer device 300 may measure an accuracy of each of the plurality of deep learning models by applying a representative dataset generated in advance to represent an arbitrary environment to each of the plurality of deep learning models. Since an environmental characteristic is different for each environment in which a corresponding deep learning model is deployed, the deep learning model capable of better representing the corresponding environment may be different. Therefore, the computer device 300 may measure an accuracy of each of the plurality of deep learning models by applying the representative dataset generated in advance to represent the arbitrary environment. Here, since a method of measuring an accuracy of a deep learning model for a specific dataset is well known, a further description related thereto is omitted.

In operation 440, the computer device 300 may determine one of the plurality of deep learning models as a final quantization model for the arbitrary environment based on the measured accuracy. For example, the computer device 300 may determine a deep learning model with a largest accuracy among the plurality of deep learning models as the final quantization model. This final quantization model may be a deep learning model adapted to the corresponding environment.

Snice simply modifying only the quantization parameter may be processed within a few seconds, an amount of time or computing resources may be significantly reduced compared to retraining the quantization model.

In operation 450, the computer device 300 may iteratively perform operations 430 and 440 once or multiple times to different representative datasets generated in advance to represent different environments. Through this, different environment-adaptive deep learning models suitable for a plurality of different environments, respectively, may be generated.

A method widely used as metrics to represent performance of a deep learning model is an accuracy. In the example embodiment, comparison may be performed using the accuracy to evaluate the performance. That is, that a corresponding model has a higher accuracy may represent that the model has a better performance. Also, a type and a characteristic of a quantization function provided from each deep compiler or deep learning frame work is different. However, considering all this, most compilers or frameworks provide INT8 quantization function. Therefore, although all the experimental results described below relate to examples performed using INT8 quantization function of TensorFlow Lite, the example embodiments are not limited to INT8 quantization only. When FP32 type that is a default type is quantized to a fixed-point data type, a quantization parameter is necessarily generated in the corresponding conversion. Therefore, it may be easily understood that the example embodiments may apply to all the quantization for the FP data type using a number of bits less than FP 32.

Hereinafter, an example of a verification experiment related to a deep learning model adaptively tuned to an environment is described. When conducting an experiment on a known network “EfficientNetB0” using data “Imagewoof”, the accuracy of FP32 type model is about 94.32%. The accuracy of a quantized model obtained by quantizing the deep learning model is quantized to INT8 is about 84.02%.

Here, the following Table 1 shows results of obtaining a total of 20 deep learning models by variously modifying a quantization parameter of a quantized model and then measuring an accuracy. The deep learning models are generated for 20 cases (20 configurations) in which different target layers are selected and/or the clipping range is differently changed, respectively.

TABLE 1

| Model | EfficientNetBo |
|---|---|
| Dataset | Imagewoof_test |
| FP32 | 94.3242 |
| INT8 | 84.0162 |
| FP32-INT8 | 10.308 |
| Configuration | |
| configuration_1 | 83.6345 |
| configuration_2 | 83.5327 |
| configuration_3 | 83.8381 |
| configuration_4 | 87.8086 |
| configuration_5 | 88.5722 |
| configuration_6 | 83.4564 |
| configuration_7 | 82.9982 |
| configuration_8 | 83.5327 |
| configuration_9 | 83.3291 |
| configuration_10 | 83.66 |
| configuration_11 | 82.8201 |
| configuration_12 | 83.3291 |
| configuration_13 | 82.311 |
| configuration_14 | 85.2634 |
| configuration_15 | 83.7109 |
| configuration_16 | 81.8274 |
| configuration_17 | 83.4309 |
| configuration_18 | 82.9473 |
| configuration_19 | 83.4054 |
| configuration_20 | 83.6345 |

Referring to Table 1, an accuracy of “configuration_5” is 88.5722% and in the case of applying a deep learning model of which a quantization parameter is modified according to “configuration_5”, a model with an accuracy of 4.56% p higher than that of the existing quantized model may be obtained even with a model quantized to the same INT8. That is, in the case of tuning the existing quantized model by adopting “configuration_5”, a new model that well reflects a characteristic of an environment in which a corresponding deep learning model is deployed may be obtained. That is, although the same results are obtained as a general method of obtaining a new model through finetuning, training is not performed in this process. Therefore, it is possible to easily and quickly obtain an environment-adapted model compared to the existing method.

Hereinafter, an example of an experiment of verifying results about an experiment conducted on an actual inference environment dataset is described.

To model data of an environment in which a deep learning model is actually deployed, datasets that represent various environments were arbitrarily generated using an augmentation method. A total of five datasets were generated and specified as Imagewoof_train1 (I_t1) to Imagewoof_train5 (I_t5). The five datasets may represent different five environments each in which a deep learning model is deployed, respectively.

The following Table 2 shows results of generating a plurality of deep learning models (in which a quantization parameter is modified) by applying the same 20 configurations (configuration_1 (c_1) to configuration_20 (c_20)) used in the previous experiment and then measuring an accuracy for the arbitrarily generated five datasets. For comparison, Table 2 shows accuracies of existing datasets.

TABLE 2

| Model | EfficientNetBo | | | | | |
|---|---|---|---|---|---|---|
| Dataset | Imagewoof_test | I_t1 | I_t2 | I_t3 | I_t4 | I_t5 |
| FP32 | 94.3242 | 91.7222 | 91.0555 | 89.7777 | 89.9444 | 90.5205 |
| INT8 | 84.0162 | 78.6666 | 79.6111 | 78.7222 | 77.8888 | 78.1369 |
| FP32-INT8 | 10.308 | 13.0556 | 11.4444 | 11.0555 | 12.0556 | 12.3836 |
| Configuration | | | | | | |
| c_1 | 83.6345 | 79.3333 | 79.0556 | 78.4444 | 77.8333 | 78.3562 |
| c_2 | 83.5327 | 78.9444 | 78.9444 | 77.8333 | 78.5556 | 78.4658 |
| c_3 | 83.8381 | 80.8333 | 80.3333 | 79.5 | 79.5556 | 78.137 |
| c_4 | 87.8086 | 83.5 | 83.8889 | 81.3333 | 82.2222 | 81.4247 |
| c_5 | 88.5722 | 82.4444 | 83.1111 | 81 | 81.8889 | 81.6986 |
| c_6 | 83.4564 | 79.3333 | 77.8889 | 78.7778 | 78.3889 | 77.9178 |
| c_7 | 82.9982 | 80.1111 | 79.3333 | 79.6667 | 79.4444 | 78.9589 |
| c_8 | 83.5327 | 80.7222 | 80.6111 | 79.7222 | 78.8889 | 77.863 |
| c_9 | 83.3291 | 78.9444 | 77.5556 | 78.5556 | 77.6667 | 74.2466 |
| c_10 | 83.66 | 79.5556 | 78.1667 | 78.8889 | 78.2222 | 78.9041 |
| c_11 | 82.8201 | 77.2222 | 76.9444 | 76.1111 | 75.0556 | 78.7397 |
| c_12 | 83.3291 | 78.9444 | 77.8333 | 78.3889 | 77.3889 | 78.0274 |
| c_13 | 82.311 | 79.3889 | 78.5 | 78.8889 | 77.4444 | 78.7945 |
| c_14 | 85.2634 | 80.7222 | 79.2778 | 78.3333 | 78.2222 | 77.9726 |
| c_15 | 83.7109 | 79.5 | 77.8333 | 77.8333 | 77.8889 | 78.3562 |
| c_16 | 81.8274 | 78.9444 | 77.8333 | 76.7778 | 77.1667 | 76.9863 |
| c_17 | 83.4309 | 79.7778 | 78.1667 | 78.5 | 78.0556 | 78.2466 |
| c_18 | 82.9473 | 80.0556 | 79.8889 | 78.1667 | 78 | 78.7397 |
| c_19 | 83.4054 | 78.6667 | 78.6667 | 78.5 | 78.5556 | 78.411 |
| c_20 | 83.6345 | 80.4444 | 79.4444 | 78.8889 | 79 | 78.4658 |

A configuration that obtains the highest performance for five environments represented by five datasets is different for each place. For Imagewoof_train_1 to Imagewoof_train_4 (I_t1 to I_t4), configuration_4 (c_4) shows the highest performance. For Imagewoof_train5 (I_t5), configuration_5 (c_5) shows the highest performance. A configuration showing the highest performance is different for each place since an environmental characteristic is different for each place and a configuration capable of well reflecting a corresponding difference is different. That is, in the case of generating a new deep learning model (a quantization model in which a quantization parameter is modified) using each of a plurality of configurations according to example embodiments, a new model more suitable for a characteristic of each place may be conveniently generated.

According to some example embodiments, it is possible to recover a degradation in an accuracy using a quantization model generated by a compiler and a quantization parameter present in the quantization model without modifying an internal code of a deep learning compiler. Also, it is possible to generate an environment-adaptive deep learning model by calibrating a quantization parameter of a quantization model that is generated by quantizing the deep learning model. Also, since the quantization model is not trained through finetuning, it is possible to significantly decrease cost such as an amount of time and computing resources compared to an existing method.

The systems and/or apparatuses described herein may be implemented using hardware components, software components, and/or a combination thereof. For example, apparatuses and components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. Also, the media may include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software. Examples of the program instructions include a machine language code such as produced by a compiler and an advanced language code executable by a computer using an interpreter.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of optimizing a quantization model, performed by a computer device comprising at least one processor, the method comprising:
receiving, by the at least one processor, an input of the quantization model;
extracting, by the at least one processor, at least one of a weight and an activation, and a quantization parameter of the at least one of the weight and the activation by analyzing the input quantization model;
selecting, by the at least one processor, at least one of the weight and the activation of the input quantization model as a target element to be modified;
adjusting, by the at least one processor, a clipping range related to the quantization parameter of the target element;
recomputing, by the at least one processor, the quantization parameter of the target element based on the adjusted clipping range; and
generating, by the at least one processor, an adjusted quantization model by applying the recomputed quantization parameter to the input quantization model.

2. The method of claim 1, wherein the selecting the target element comprises selecting the target element for each channel or for each layer of the input quantization model.

3. The method of claim 1, wherein the adjusting the clipping range comprises adjusting the clipping range by increasing or decreasing at least one of a minimum value and a maximum value for the selected target element.

4. The method of claim 1, wherein the recomputing the quantization parameter comprises recomputing a scale factor and a zero point as the quantization parameter of the target element according to the adjusted clipping range.

5. The method of claim 1, wherein the selecting at least one of the weight and the activation, the adjusting the clipping range and the recomputing the quantization parameter are iteratively performed.

6. The method of claim 5, further comprising:
determining the recomputed quantization parameter among a plurality of candidate quantization parameters obtained by iteratively performing the selecting, the adjusting and the recomputing.

7. A method of optimizing a quantization model performed by a computer device comprising at least one processor, the method comprising:
receiving, by the at least one processor, an input of the quantization model;
generating, by the at least one processor, a plurality of deep learning models by modifying a quantization parameter of the input quantization model;
measuring, by the at least one processor, an accuracy of each of the plurality of deep learning models by applying a representative dataset generated in advance to represent an arbitrary environment to each of the plurality of deep learning models; and
determining, by the at least one processor, one of the plurality of deep learning models as an optimized quantization model for the arbitrary environment based on the measured accuracy,
wherein the modifying the quantization parameter of the input quantization model comprises:
selecting at least one of the weight and the activation of the input quantization model as a target element to be modified;
adjusting a clipping range related to the quantization parameter of the target element; and
modifying the quantization parameter of the target element based on the adjusted clipping range.

8. The method of claim 7, wherein the selecting the target element comprises selecting the target element for each channel or for each layer of the input quantization model.

9. The method of claim 7, wherein the adjusting the clipping range comprises adjusting the clipping range by increasing or decreasing at least one of a minimum value and a maximum value for the selected target element.

10. The method of claim 7, wherein the modifying the quantization parameter of the target element comprises recomputing a scale factor and a zero point as the quantization parameter of the target element according to the adjusted clipping range.

11. The method of claim 7, wherein the plurality of deep learning models are generated so that a target element or an adjusted clipping range of one of the plurality of deep learning models is different from others of the plurality of deep learning models.

12. The method of claim 7, wherein the measuring the accuracy and the determining as the optimized quantization model are iteratively performed to different representative datasets generated in advance to represent different environments.

13. A computer device comprising:
at least one processor configured to execute a computer-readable instruction on the computer device,
wherein the at least one processor is configured to,
receive an input of a quantization model,
extract at least one of a weight and an activation, and a quantization parameter of the at least one of the weight and the activation by analyzing the input quantization model,
select at least one of the weight and the activation of the input quantization model as a target element to be modified,
adjust a clipping range related to the quantization parameter of the target element,
recompute the quantization parameter of the target element based on the adjusted clipping range, and
generate an adjusted quantization model by applying the recomputed quantization parameter to the input quantization model.

14. The computer device of claim 13, wherein, to select the target element, the at least one processor is configured to select the target element for each channel or for each layer of the input quantization model.

15. The computer device of claim 13, wherein, to adjust the clipping range, the at least one processor is configured to adjust the clipping range by increasing or decreasing at least one of a minimum value and a maximum value for the selected target element.

16. The computer device of claim 13, wherein, to recompute the quantization parameter, the at least one processor is configured to recompute a scale factor and a zero point as the quantization parameter of the target element according to the adjusted clipping range.

17. The computer device of claim 13, wherein a process of the selecting at least one of the weight and the activation, a process of the adjusting the clipping range and a process of the recomputing the quantization parameter are iteratively performed.

18. The computer device of claim 17, wherein the at least one processor is further configured to determine the recomputed quantization parameter among a plurality of candidate quantization parameters obtained by iteratively performing the process of the selecting, the process of the adjusting and the process of the recomputing.
